(19) United States
(12) Patent Application Publication
(10) Pub. No.: US 2004/0039464 A1
(43) Pub. Date: Feb. 26, 2004

(54) Enhanced error concealment for spatial audio

(75) Inventors: Jussi Virolainen, Espoo (FI); Ari Lakaniemi, Helsinki (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/465,909

(22) Filed: Jun. 13, 2003

(30) Foreign Application Priority Data
Jun. 14, 2002 (WO) PCT/IB02/02193

(51) Int. Cl. G06F 17/00; H04R 5/00

(52) U.S. Cl. 700/94; 381/56; 381/1

(57) ABSTRACT

An error concealment method for multi-channel digital audio involves receiving an audio signal having audio data forming a first audio channel and a second audio channel included therein, wherein the first and second audio channels are correlated with each other in a manner so that a spatial sensation is typically perceived when listened to by a user. Erroneous first-channel data is detected in the first audio channel, and second-channel data is obtained from the second audio channel. The erroneous first-channel data of the first audio channel is corrected by using the second-channel data. Upon detection of the erroneous first-channel data, a spatially perceivable inter-channel relation between the first and second audio channels is determined, and the determined inter-channel relation is used when correcting the erroneous first-channel data of the first audio channel so as to preserve the spatial sensation perceived by the user.

### CROSS-REFERENCE TO RELATED APPLICATION

Priority is claimed under 35 U.S.C. 119 from International Application PCT/IB02/02193 filed Jun. 14, 2002.

### FIELD OF THE INVENTION

The present invention relates to an error concealment method for multi-channel digital audio, where an audio signal is received which has audio data forming a first audio channel and a second audio channel included therein, said first and second audio channels being correlated with each other in a manner so that a spatial sensation is typically perceived when the signal is listened to by a user.

More specifically, the present invention relates to an error concealment method, where erroneous first-channel data is detected in the first audio channel, second-channel data is obtained from the second audio channel, and the erroneous first-channel data of the first audio channel is corrected by using the second-channel data.

### BACKGROUND OF THE INVENTION

Multi-channel audio is used in various applications, such as high-quality (stereo) music or audio conferencing (teleconferencing), for creating an impression of the direction of the sound source in relation to the listener (user). Thus, the multi-channel audio generates a spatial effect. In the case of audio conferencing, the spatial effect is created artificially by spatialization in the teleconference bridge, and in the case of stereo music the effect is created already by the recording (or mixing) arrangement. Reference will now be made, in an exemplifying manner, to a teleconferencing system including not only a teleconference bridge but also, of course, a plurality of user terminals which are all coupled to the teleconference bridge through a communications network, such as a packet-switched mobile telecommunications or data communications network. One example of a teleconferencing system is shown in FIG. 3.

The conference bridge 300 is responsible for receiving mono audio streams from microphones 312, 322, 332, 342 of a plurality of user terminals 310, 320, 330 340 and processing these mono streams (in terms of e.g. automatic gain control, active stream detection, mixing and spatialization, as well as artificial reverberation) so as to provide a stereo output signal to the user terminals. The user terminals are responsible for the actual audio capture (through microphones 312, 322, 332, 342) and audio reproduction (through speaker pairs 314/316, 324/326, 334/336, 344/346). The stereophonic connection from the teleconference bridge to the user terminal makes it possible to transmit spatial audio which is processed for headphones or loudspeakers. Sound sources can be spatialized around the user by exploiting known 3D audio techniques, such as HRTF filtering (“Head Related Transfer Function”). Use of spatial audio improves speech intelligibility and facilitates speaker detection and separation. Moreover, it will let the conference environment sound more natural and satisfactory. The stereophonic sound can be transmitted as two separately coded mono channels or as one stereo-coded channel. Alternatively, the stereophonic sound can be transmitted on one mono channel, e.g., in which channels are interleaved.

Transmission errors can have harmful side effects in spatial audio conferencing systems. When speech frames from one or both channels are lost, the perceived spatial image will very likely shift its location. The shifting can be very disturbing for the listener. For example, a sound source, which was spatialized at the listeners left side, may shift rapidly to the center or even to the other side and back again. Whereas in monophonic conferencing the user would not even notice some frame errors, the spatial dimension of stereo conferencing will make these errors all the more noticeable. This is a problem especially in cases where two independent instances of a speech codec originally designed for single channel are used to process two channels of a stereo conference.

If frames are corrupted or even lost during transmission, the speech decoder typically uses error concealment (masking) methods that are based on extrapolation to substitute the erroneous or missing frames in the output speech signal. The extrapolation is based on previous frames in the same channel. This sort of error concealment is designed for monophonic signals and does not generally perform well with spatialized signals. When such known single-channel based error concealment methods are used for spatialized multi-channel audio, the result can be a shifting spatial image during frame errors. Stationary spatial image requires that the phase differences between the signal components of the channels be preserved in all circumstances. Single-channel based error concealment methods cannot guarantee that the extrapolated signals are correctly phase-shifted (and linearly filtered) copies of each other.

Typically, the worst case would occur during unvoiced phonemes, where extrapolation cannot preserve the phase difference between the channels, because generally the error concealment methods cannot reconstruct the details of the missing unvoiced (noise-like) signal as accurately as would be required to preserve the desired phase difference. The reason for this is that an unvoiced signal typically resembles white noise and cannot therefore be effectively predicted/extrapolated. In a single-channel case, good error concealment performance for an unvoiced signal can be reached simply by generating a noise-like signal with constant or smoothly changing energy level. Unfortunately, however, this does not work well for a spatialized multi-channel signal, since the correlation between the channels (that are processed independently of each other) would be lost.

The nature of the errors depends on the transmission system. The errors occurring in an over-the-air connection typically differ from buffer overflow to errors in network routers. The errors may appear as single frame errors or error bursts where typically several consecutive frames are lost. The transmission system also determines whether the channels are transmitted and possibly routed independently from each other or as a common “interleaved” channel. Thus, speech frames may be lost at one of the channels only but also simultaneously at both of the channels.

If the error affects only one of the channels, an attempt can be made to correct the error by using data from the unaffected other channel. In such a case, if the other channel is simply copied over the erroneous channel, this replacement operation would set the actual phase difference between the signals to zero for the erroneous frame. For example, if the sound source is spatialized to the listener's side when there is an interaural time difference, as a result of the replacement operation, the directional impression of the sound would be quickly lost by the human auditory system. Already a few successive monophonic samples are perceived as a change of the sound position. In addition, for a voiced (periodic) signal, the replacement operation would also introduce discontinuity in the periodic signal structure. Because human hearing is very sensitive to such discontinuities, annoying clicks will often be heard at boundaries of actually received and replaced parts of the signal, and the sound source will appear to move towards the center. Therefore, this method does not work for spatial audio.

To avoid a shift in spatial position during frame loss, it is previously known to fade both channels out (muting). This, however, has a drawback in that a silent gap will be caused whenever an error is detected. A silent gap during continuous speech will be disturbing, especially when there is noticeable background noise at the remote speaker location.

U.S. Pat. No. 6,351,727 and U.S. Pat. No. 6,351,728 present various error concealment methods in line with those described above, such as muting, left-right substitution, repeating and estimating. Instead of merely performing the error concealment upon an entire audio frame in which an error has been detected during decoding, U.S. Pat. No. 6,351,727 and U.S. Pat. No. 6,351,728 suggest replacing only those portions which actually contain errors. These portions of an audio frame may be certain (groups of) spectral values or sub-bands, including time domain sample values or spectral domain sample values. The error concealment may also be based on certain parameters from the decoder, such as scale factors or other control data.

### SUMMARY OF THE INVENTION

In view of the above, an objective of the invention is to solve or at least reduce the problems discussed above. More particularly, a purpose of the invention is to prevent a shift in the spatial position of a sound source when concealing frame errors. Thus, the invention seeks to preserve the spatial position or sensation which is perceived by a user when listening to multi-channel audio, even if errors are generated and corrected by inter-channel use of audio data.

Generally, the above objectives are achieved by an error concealment method, a receiver of multi-channel digital audio, a computer program product, an integrated circuit, a user terminal and a teleconference system according to the description which follows.

Simply put, to achieve the above, the invention exploits co-channel redundancy of spatial audio for error concealment. If an audio frame is corrupted or missing in one of the channels, audio data from the correctly received channel is used to reconstruct the erroneous frame. The invention may be carried out in the time domain, wherein an inter-channel time difference or phase difference between the channels is determined and used when reconstructing the erroneous frame, so that the perceived spatial position of the sound source is preserved. The invention may also be carried out in a “parameter domain”, in conjunction with a speech codec known per se, wherein an erroneous frame on one channel is reconstructed from parameter data of previous frames on that channel but also from parameter data of a concurrent non-erroneous frame on the other channel.

If audio frames are simultaneously corrupted or missing in both of the channels, to prevent a shift of sound source location, the audio signal for one channel is first reconstructed by using an error concealment method known per se (such as extrapolation from preceding frames in that channel), and then the other channel is reconstructed based on the first reconstructed channel in the manner described above.

One advantage of the invention is that not only a single erroneous frame but also longer sequences of consecutive erroneous frames may be corrected without significant loss of perceived spatial position.

A first aspect of the invention is an error concealment method for multi-channel digital audio. The method comprises the steps of

receiving an audio signal having audio data forming a first audio channel and a second audio channel included therein, said first and second audio channels being correlated with each other in a manner so that a spatial sensation is typically perceived when listened to by a user;

detecting erroneous first-channel data in the first audio channel;

obtaining second-channel data from the second audio channel;

determining, upon detection of the erroneous first-channel data, a spatially perceivable inter-channel relation between the first and second audio channels; and

correcting the erroneous first-channel data of the first audio channel by using the second-channel data and the determined inter-channel relation so as to preserve the spatial sensation perceived by the user.

The erroneous first-channel data of the first audio channel may be corrected by manipulating the second-channel data in accordance with the determined inter-channel relation and then replacing the erroneous first-channel data with the manipulated second-channel data.

In one embodiment, the determined inter-channel relation may be a phase difference between the first and second audio channels. The manipulation of the second-channel data may then comprise selecting the second-channel data from the second audio channel with a time shift with respect to the first audio channel, said time shift corresponding to the determined phase difference.

The phase difference may be determined by analyzing the first and second channels of the received audio signal with respect to each other. This analysis may involve calculating the cross-correlation between the channels. It may alternatively involve low-pass filtering of each of the first and second channels, and detecting the phases of the first and second channels after low-pass filtering by matching peaks or zero-crossings or both in voiced phonemes.

In another embodiment, the determined inter-channel relation or phase difference may be determined from metadata received together with the audio signal.

The method may involve an additional step of decoding the received audio signal prior to detecting erroneous first-channel data in the first audio channel.

The first and second audio channels may each comprise a plurality of audio frames, and the detection and correction of erroneous first-channel data may concern at least one entire audio frame. Alternatively, the detection and correction of erroneous first-channel data may concern only part(s) of an audio frame, such as certain spectral sub-band(s), or even parts thereof.

As yet another alternative, the detection and correction of erroneous first-channel data may concern only some audio component(s), such as principal audio component(s), which is/are detected or indicated to be present in the audio signal.

The detection and correction of erroneous first-channel data may be performed in the time domain upon a plurality of time domain audio samples contained in the audio frame.

The first and second audio channels may be left and right stereo channels, or vice versa. The first and second audio channels may also be any correlated channels of a 4.1, 5.1 or 6.1 digital audio format, or any other so-called 3D or spatial audio format, or in general any two channels which carry audio information and are temporally highly correlated, i.e., derived essentially from the same sound source.

In one embodiment, capable of concurrent error concealment for both channels, the method may comprise the additional steps, after detecting erroneous first-channel data in the first audio channel, of:

detecting erroneous second-channel data in the second audio channel, essentially concurrent with the erroneous first-channel data detected in the first audio channel;

selecting either the first audio channel or the second audio channel as source channel for audio reconstruction;

reconstructing the erroneous data of the selected source channel from preceding data in the selected source channel; and

reconstructing the erroneous data of the other of the first and second audio channels, which was not selected as source channel, from the reconstructed data of the source channel in the manner described above.

In this embodiment, the one of the first audio channel or the second audio channel which has the highest signal energy or power level, or alternatively the one which is leading in terms of phase, may be selected as source channel. In the reconstruction, it may then be necessary either to buffer the data from the source channel to obtain a full frame to the other channel, or to buffer the data obtained to the other channel before encoding.

The step of reconstructing the erroneous data of the selected source channel from preceding data in the selected source channel may be performed by attenuated extrapolation or copying of the preceding data.

After having reconstructed the first and second audio channels, the reconstructed audio data may be attenuated, and the first and second audio channels may be maintained attenuated for as long as there are consecutive errors on the first and second audio channels Then, upon detecting that there are no more consecutive errors on the first and second audio channels, the first and second audio channels may be amplified to cancel the attenuation thereof.

The audio signal may be received from a teleconference bridge over at least one packet-switched communications network, such as an IP based network. The audio signal may also be received from a stereo music server, and/or over a radio network, a fixed telecommunications network, a mobile telecommunications network, a short-range optical link or a short-range radio link.

The step of correcting the erroneous first-channel data of the first audio channel may involve using the second-channel data of the second audio channel as well as preceding non-erroneous first-channel data of the first audio channel.

A second aspect of the invention is a computer program product directly loadable into a memory of a processor, where the computer program product comprises program code for performing the method according to the first aspect when executed by the processor.

A third aspect of the invention is an integrated circuit, which is adapted to perform the method according to the first aspect.

A fourth aspect of the invention is a receiver of multi-channel digital audio, comprising

means for receiving an audio signal having audio data forming a first audio channel and a second audio channel included therein, said first and second audio channels being correlated with each other in a manner so that a spatial sensation is typically perceived when listened to by a user;

means for detecting erroneous first-channel data in the first audio channel;

means for obtaining second-channel data from the second audio channel; and

means for correcting the erroneous first-channel data of the first audio channel by using the second-channel data;

as well as

means for determining, upon detection of the erroneous first-channel data, a spatially perceivable inter-channel relation between the first and second audio channels, wherein

said means for correcting the erroneous first-channel data of the first audio channel is adapted to use the determined inter-channel relation when correcting the erroneous first-channel data so as to preserve the spatial sensation perceived by the user.

The receiver may further comprise means for performing the method according to the first aspect.

A fifth aspect of the invention is a user terminal for a communications network, the user terminal comprising at least one of an integrated circuit according to the third aspect or a receiver according to the fourth aspect. The communications network may include a mobile telecommunications network, and the user terminal may be a mobile terminal.

The user terminal may be adapted to receive the audio signal from a teleconference bridge over the communications network.

A sixth aspect of the invention is a teleconference system comprising a communications network, a plurality of user terminals according to the fifth aspect and a teleconference bridge, wherein the user terminals are connected to the teleconference bridge over the communications network.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated otherwise.

### BRIEF DESCRIPTION OF THE DRAWINGS

The present invention will now be described in more detail, reference being made to the enclosed drawings, in which:

FIG. 1 is a schematic illustration of a telecommunication system used for transmission of stereo music from a remote server to a mobile terminal, as one example of a case where the present invention may be applied.

FIG. 2 is a schematic block diagram illustrating some of the elements of FIG. 1.

FIG. 3 is a schematic illustration of a teleconference system including a teleconference bridge and a plurality of user terminals, as another example of a case where the present invention may be applied.

FIG. 4 is a schematic block diagram of one of the user terminals in FIG. 3 according to one embodiment.

FIG. 5 is a schematic block diagram of one of the user terminals in FIG. 3 according to another embodiment.

FIG. 6 illustrates the general error concealment approach according to the invention, where a left stereo channel is used as a source for reconstructing an erroneous right stereo channel together with a determined inter-channel time difference (phase difference between the channels).

FIG. 7 is similar to FIG. 6 but illustrates the opposite situation, where a right stereo channel is used as a source for reconstructing an erroneous left stereo channel together with a determined inter-channel time difference (phase difference between the channels).

FIG. 8 is a flow chart which illustrates the main steps for error concealment according to the invention, when one channel contains an erroneous frame.

FIG. 9 is a flow chart which illustrates the main steps for error concealment according to the invention, when both channels simultaneously contain erroneous frames.

FIG. 10 shows a simplified block diagram of an AMR (Adaptive Multi-Rate) audio decoder.

### DETAILED DESCRIPTION OF THE INVENTION

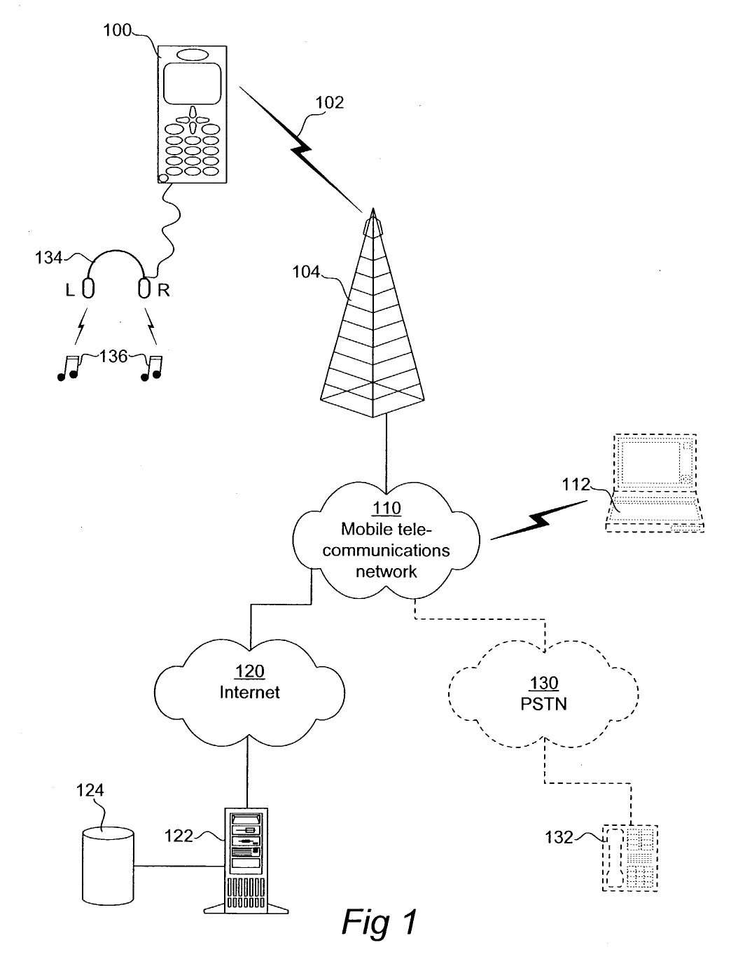

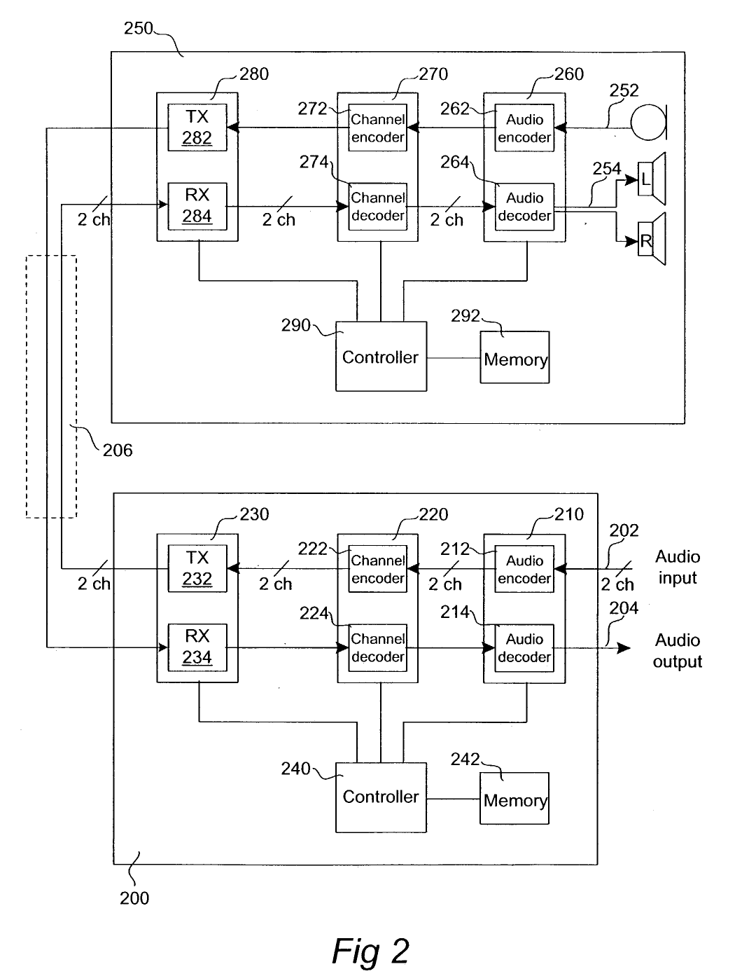

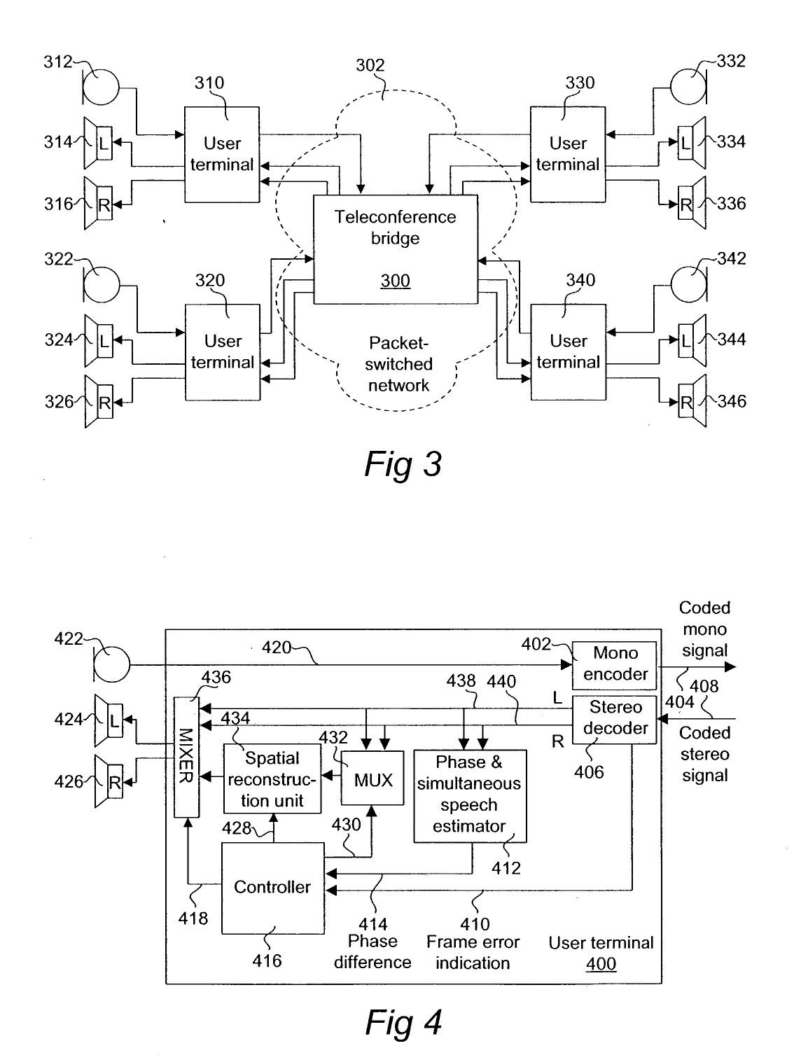

First, with reference to FIGS. 1 and 2, one example of a multi-channel audio application will be described in the form of a telecommunication system for transmission of stereo music from a remote server to a mobile terminal. Then, with reference to FIGS. 3-5, another example of a multi-channel audio application will be described in the form of a teleconferencing system. The error concealment method according to the invention will be described in detail with reference to FIGS. 6-10, wherein the teleconference system of FIGS. 3-5 will serve as a base in a non-limiting manner; the error concealment method may equally well be applied to the telecommunication system of FIGS. 1-2 as well as in various other applications not explicitly described herein, as will be apparent to a skilled person.

In the telecommunication system of FIG. 1, multichannel audio in the form of for instance digitally encoded stereo music may be stored in a database 124 to be delivered from a server 122 over the Internet 120 and a mobile telecommunications network 110 to a mobile telephone 100. To this end, the mobile telephone 100 may be equipped with a stereo headset 134, through which a user of the mobile telephone 100 may listen to stereo music 136 from the server 122. Instead of being stored in a database 124, the multi-channel audio provided by the server 122 may be read directly from an optical storage, such as a CD or DVD. Moreover, the server 122 may be connected to or included in a radio broadcast station so as to provide streaming audio services across the Internet 120 to the mobile telephone 100. The mobile telephone may be any commercially available device for any known mobile telecommunications system, including but not limited to GSM, UMTS, D-AMPS or CDMA2000.

The system in FIG. 1 may be used for audio conferencing. Either the audio conferencing arrangement may be pre-arranged and controlled by the server 122 residing in the network, as has traditionally been the case, or the audio conference may be formed as a so-called “ad hoc conference”, wherein one terminal device (e.g. mobile telephone 100) contacts at least two other terminals and arranges the conference. In the latter case, one of the terminals may also contain server functionality, and it may not be necessary to have any network server at all. Such systems as presented above can be envisioned, e.g., in connection with the rich call services provided by the 3G and 4G networks.

Of course, multi-channel audio as well as various other data such as monophonic speech, video, images and text messages may be communicated between different units 100, 112, 122 and 132 by means of different networks 110, 120 and 130. For instance, the portable device 112 may be a personal digital assistant, a laptop computer with a GSM or UMTS interface, a smart headset or another accessory for such devices, etc. Moreover, speech may be communicated from a user of a stationary telephone 132 through a public switched telephone network (PSTN) 130 and the mobile telecommunications network 110, via a base station 104 thereof across a wireless communication link 102 to the mobile telephone 100, and vice versa. FIG. 2 presents a general block diagram of a mobile audio data transmission system, including a user terminal 250 and a network station 200. The user terminal 250 may for instance represent the mobile telephone 100 of FIG. 1, whereas the network station 200 may for instance represent the base station 104 or the server 122 in FIG. 1, or alternatively a teleconference bridge 300 shown in FIG. 3.

The user terminal 250 may communicate single-channel (mono) audio such as speech through a transmission channel 206 to the network station 200. The transmission channel 206 may be provided by the wireless link 102, the mobile telecommunications network 110 or the Internet 120 in FIG. 1, or a packet-switched network 302 in FIG. 3, or any such combination. A microphone 252 may receive acoustic input from a user of the user terminal 250 and convert the input to a corresponding analog electric signal, which is supplied to an audio encoding/decoding block 260. This block has an audio encoder 262 and an audio decoder 264, which together form an audio codec. The analog microphone signal is filtered, sampled and digitized, before the audio encoder 262 performs audio encoding applicable to transmission channel 206. An output of the audio encoding/decoding block 260 is supplied to a channel encoding/decoding block 270, in which a channel encoder 272 will perform channel encoding upon the encoded audio signal in accordance with the applicable standard for the transmission channel 206.

An output of the channel encoding/decoding block 270 is supplied to a radio frequency (RF) block 280, comprising an RF transmitter 282, an RF receiver 284 as well as an antenna (not shown in FIG. 2). As is well known in the technical field, the RF block 280 comprises various circuits such as power amplifiers, filters, local oscillators and mixers, which together will modulate the encoded audio signal onto a carrier wave, which is emitted as electromagnetic waves propagating from the antenna of the user terminal 250.

After having been communicated across the channel 206, the transmitted RF signal, with its encoded audio data included therein, is received by an RF block 230 in the network station 200. In similarity with block 280 in the user terminal 250, the RF block 230 comprises an RF transmitter 232 as well as an RF receiver 234. The receiver 234 receives and demodulates, in a manner which is essentially inverse to the procedure performed by the transmitter 282 as described above, the received RF signal and supplies an output to a channel encoding/decoding block 220. A channel decoder 224 decodes the received signal and supplies an output to an audio encoding/decoding block 210, in which an audio decoder 214 decodes the audio data which was originally encoded by the audio encoder 262 in the user terminal 250. A decoded audio output 204, for instance a PCM signal, may be forwarded within the mobile telecommunications network 110, the PSTN 130, the Internet 120, the packet-switched network 302 in FIG. 3, etc. (or to a spatial processing/mixing unit inside the network station 200, in case it is a teleconference bridge).

When stereo audio data is communicated in the opposite direction, i.e. from the network station 200 to the user terminal 250, a stereo audio input signal 202 is received from e.g. the server 122 by an audio encoder 212 of the audio encoding/decoding block 210. After having applied audio encoding to the audio input signal, channel encoding is performed by a channel encoder 222 in the channel encoding/decoding block 220. Then, the encoded audio signal is modulated onto a carrier wave by a transmitter 232 of the RF block 230 and is communicated across the channel 206 to the receiver 284 of the RF block 280 in the user terminal 250. An output of the receiver 284 is supplied to the channel decoder 274 of the channel encoding/decoding block 270, is decoded therein and is forwarded to the audio decoder 264 of the audio encoding/ decoding block 260. The audio data is decoded by the audio decoder 264 and is ultimately converted to a pair of analog signals 254, which are filtered and supplied to left and right speakers for presentation of the received audio signal acoustically to the user of the user terminal 250.

As is generally known, the operation of the audio encoding/decoding block 260, the channel encoding/decoding block 270 as well as the RF block 280 of the user terminal 250 is controlled by a controller 290, which has associated memory 292. Correspondingly, the operation of the audio encoding/decoding block 210, the channel encoding/decoding block 220 as well as the RF block 230 of the network station 200 is controlled by a controller 240 having associated memory 242.

Even if the audio transmission was described above as single-channel (mono) from user terminal to network station but as multi-channel (stereo) in the opposite direction from network station to user terminal, it is to be understood that this does not necessary always have to be the case. As an example, mono audio (normal telephone speech) may for instance be communicated from network station to user terminal in addition to the stereo audio referred to above.

In the centralized stereo teleconferencing system of FIG. 3, a plurality of user terminals 310, 320, 330, 340 are connected to the central teleconference bridge 300 through an error-prone network 302, such as a packet-switched IP network. In operation, the teleconference bridge 300 will receive mono audio streams from the user terminals 310, 320, 330, 340 and process these mono audio streams to spatialize them into a stereo output signal which is supplied to the user terminals. Spatialization can be done e.g. by HRTF (head-related transfer function) filtering the input signals, thus producing a binaural output signal for each of the listeners (for headphone listening). The spatialized stereo audio thus achieved will improve speech intelligibility and facilitate speaker detection and separation, compared to mono teleconferencing. It will also provide a conference environment sound which is more natural and satisfactory.

When there is only one active speaker at the same time, the left and right channels are highly redundant. In theory, if one of these two channels is present, the other can be reconstructed from the existing one. For example, a binaural signal produced using HRTF processing (linear filtering) satisfies these requirements. However, the exact reconstruction requires knowledge of phase difference and the frequency dependent interaural level difference (ILD) between the channels. The phase difference is a result of interaural time difference (ITD) . ITD varies typically from −0.8 to +0.8 milliseconds corresponding −6 to +6 samples at 8 kHz sampling rate. The ILD is mainly a result of the head shadow effect. The contra-lateral (farther ear) channel has low-pass characteristics compared to the ipsi-lateral (nearer ear).

Reference is now made to FIG. 4, which shows one of the user terminals of FIG. 3 in more detail. The user terminal 400 has a first interface to the network 302 and is therefore capable of transmitting an encoded mono signal 404 to the teleconference bridge 300. A mono encoder 402 receives audio on a mono channel 420 from the microphone 422 and encodes it into the encoded mono signal 404.

The user terminal 400 is also capable of receiving an encoded stereo signal 408 from the teleconference bridge 300. A stereo decoder 406 decodes the signal 408 and forms two decoded channels 438 (left) and 440 (right), which are passed through a mixer 436 and ultimately arrive at the left speaker 424 and the right speaker 426. Alternatively, instead of receiving one encoded stereo signal 408 from the teleconference bridge 300, two separately encoded mono channels may be received, one for each stereo channel 438 and 440. As yet an alternative, the left and right channels may have been multiplexed into one common mono channel, in which channels are interleaved.

For successful error concealment with preserved spatial location of the sound source, the user terminal 400 needs to identify a phase difference between the stereo channels 438, 440 when reconstructing an erroneous frame, appearing on one of the channels, from the other channel.

As previously mentioned, the present invention is not restricted to the context of audio conferences, but can be used in the reception of any multi-channel audio signal, e.g., traditional or internet radio transmission, sound reproduced from media such as CD, minidisc, cassette or MP3 player, or any other memory medium. The reception can take place over a mobile (cellular) network such as GSM, UMTS, CDMA2000 or the like, a local area network or wide area network such as WLAN or any ad hoc radio network, or over short-range connectivity like BlueTooth or other short-range radio connection, or an optical connection such as IrDA. In such systems, there may not be provided the spatialization information needed for reconstruction of erroneous or missing data in the audio signal, and in the following, an embodiment of the invention is presented where this spatialization information is derived by analyzing the received audio signal.

In one embodiment the user terminal produces the required information on phase difference by analyzing the channels 438, 440. The exact ITD (interaural time difference) value can be determined by calculating the cross-correlation between the channels or by using a phase comparator. Because typically ITD varies between −0.8 and +0.8 ms, the cross-correlation needs to be calculated only in this window, or if the ITD sign has already been estimated, calculation can be done in half of this window. To this end, the energy ratio between the channels can be used as an estimate for the sign of the ITD value. For example, if there is more energy on the right channel (interaural level difference (ILD) detected), the sound source is more likely to have been spatialized to the listener's right side which also defines the sign for the ITD value.

An alternative approach, within the above embodiment, is as follows. The left and right channel signals could first be low-pass filtered with a cutoff frequency of, e.g., 400 Hz (the fundamental frequency of speech is typically below this). The phases of the signals could then be detected and synchronized during voiced phonemes by matching peaks and/or zero-crossings. This approach might have an advantage in requiring less computational power compared to cross-correlation. In yet another alternative approach, a method like principal-component analysis (PCA), independent-component analysis (ICA) or signal-space projection (SSP) may be used to separate the sound sources present in the sound signal. In such methods, only the strongest or some strongest independent signal(s) may be separated from the audio signal, and the correction may be applied for such part(s) only. For example, in the signal-space projection method, the strongest partial signal is first detected, and its pattern is removed from the signal. Then the strongest partial signal left in the audio signal is detected, and it is subtracted, and so on. This allows for convenient extraction of a desirable number of prominent audio components from the signal.

Referring back to FIG. 4, the stereo decoder 406 will send a frame error indication signal 410 to a controller 416 whenever a frame on either of the channels has been lost or corrupted during transmission across the network 302. The controller 416 checks whether the corresponding frame on the other channel has been received correctly. If so, the controller 416 seeks to find the phase difference between the channels before the error. This information is provided by a phase & simultaneous speech estimator 412 which is adapted to determine the phase difference as an ITD value in any of the methods referred to above. The ITD value is transmitted in a signal 414 to the controller 416.

The controller 416 controls a multiplexer 432 to select the appropriate one of channels 438 and 440, i.e. the non-erroneous channel which is to be used for frame reconstruction of the erroneous channel, to be input to a spatial reconstruction unit 434. The controller 416 also derives the ITD value from the signal 414 from the phase & simultaneous speech estimator 412 and supplies the ITD value to the spatial reconstruction unit 434. The spatial reconstruction unit 434 will prepare a frame reconstruction data set in the following manner. The ITD value is used to determine the first sample of the audio frame on the unaffected channel, which is received through the multiplexer 432 and will be used to replace the erroneous frame of the affected channel. This is illustrated in more detail in FIG. 6, where it is assumed that the sound source has been spatialized, by the teleconference bridge 300, at the listener's left side. A frame error has been determined by the stereo decoder 406 for frame #n in the right channel. Consequently, the phase & simultaneous speech estimator 412 determines that the ITD holds a value of, for instance, +6 samples, confirming that the phase of the non-erroneous left channel is ahead of the erroneous right channel. Also fractional samples may be used, but this requires interpolation during the reconstruction. The spatial reconstruction unit 434 will receive the determined ITD value from the controller 416 and prepare the frame reconstruction data set by copying audio samples starting at 6 samples before the frame boundary of the concurrent non-erroneous frame #n in the left channel. The frame reconstruction data set thus prepared has the same length as the erroneous right-channel frame #n which it is intended to replace.

In FIG. 7 a similar situation is shown, where, however, the erroneous frame #n appears in the leading channel instead, i.e. in the left channel. In this case, the frame reconstruction data set is prepared by copying audio samples starting at 6 samples after the frame boundary of the concurrent non-erroneous frame #n in the right channel.

The spatial reconstruction unit 434 will forward the prepared frame reconstruction data set to the mixer 436, optionally after first having performed further processing on the frame reconstruction data set, such as HRTF filtering or adjustment of frequency-dependent ILD level. As already mentioned, the mixer 436 also receives a continuous stream of decoded audio frames on both channels 438 and 440.

The controller 416 controls the mixer 436, through a signal 418, to replace the particular erroneous frame on either of the channels with the corresponding frame reconstruction data set prepared by the spatial reconstruction unit 434, thereby concealing the error to the listener. Thus, corrected stereo audio data arrives at the left and right speakers 424, 426. Optionally, the mixer may do cross-fade between reconstructed and non-erroneous frame boundaries.

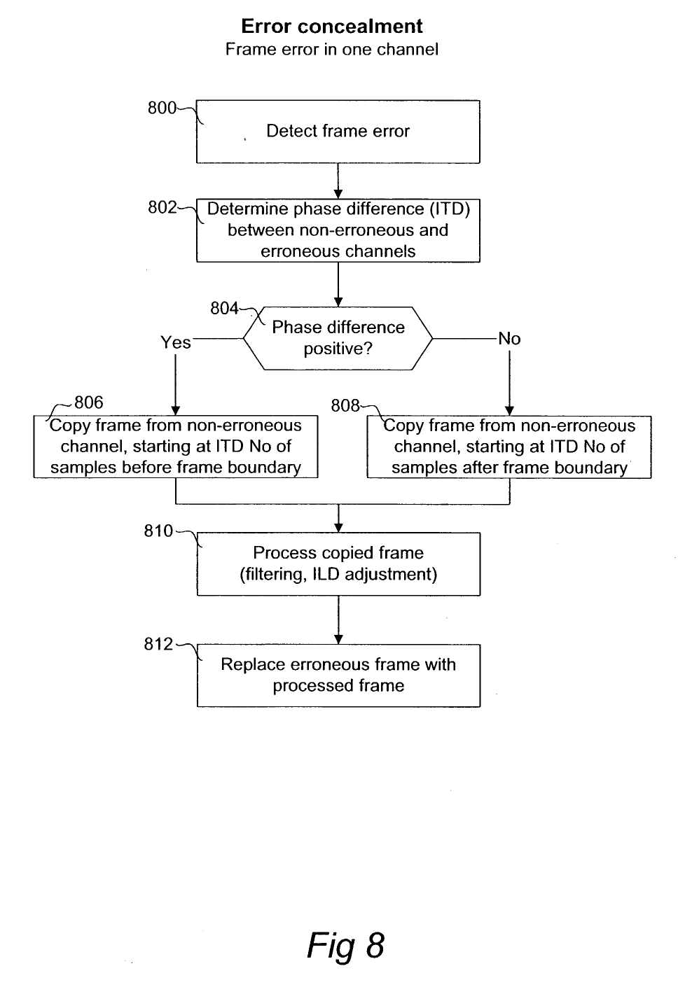

The above procedure for concealment of a frame error in one of two stereo channels is illustrated on a more conceptual level in FIG. 8. In step 800 it is initially determined that an audio frame error has occurred in one of the channels. In step 802 a phase difference (such as an ITD value) is determined between the non-erroneous channel and the erroneous channel. In step 804 it is determined whether the phase difference is positive, i.e. whether the non-erroneous channel is ahead in phase of the erroneous channel. If the answer in step 804 is affirmative, data to be used for frame reconstruction is copied, in an amount corresponding to one audio frame, from the non-erroneous channel in step 806, starting at a certain number of samples before the frame boundary, as illustrated in FIG. 6. In the opposite case, in step 808, data is instead copied from the non-erroneous channel starting at a certain number of samples after the frame boundary, as illustrated in FIG. 7.

Then, the frame reconstruction data thus prepared may be processed in step 810 in the manners indicated above. Finally, the erroneous frame on the erroneous channel is replaced by the prepared and processed frame reconstruction data in step 812.

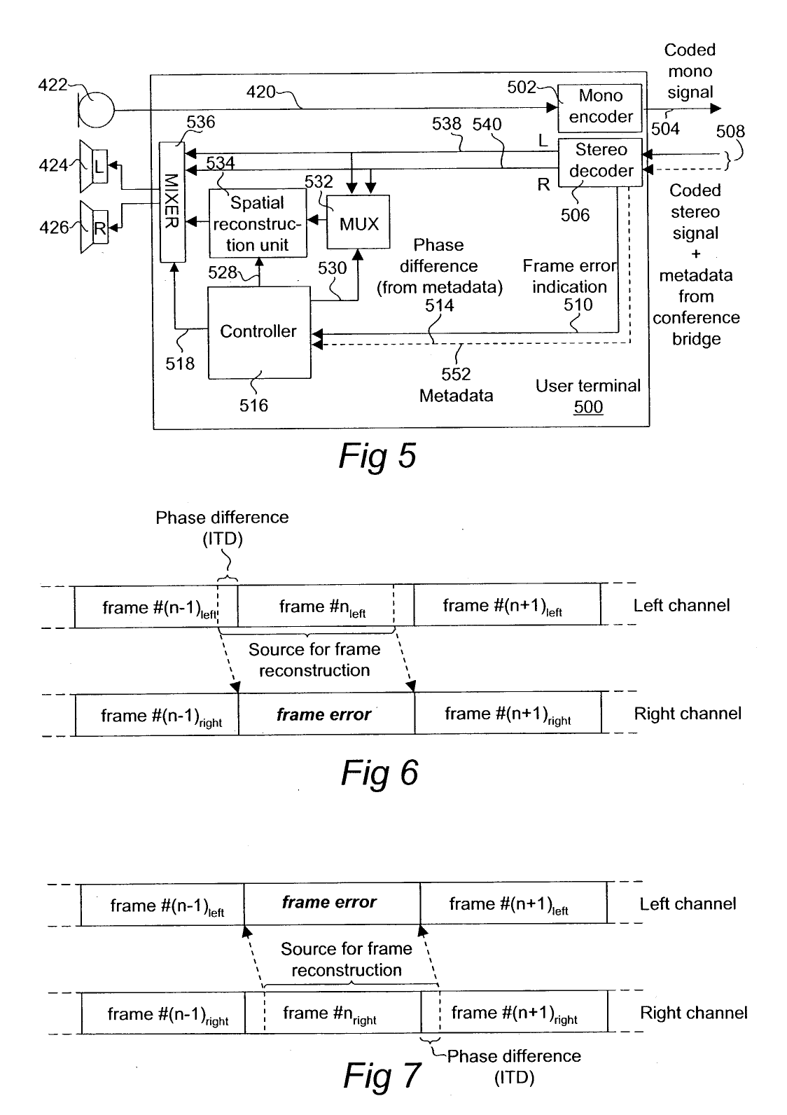

FIG. 5 illustrates an alternative embodiment of a user terminal 500 for the teleconference system of FIG. 3. Here, the required information on phase difference between audio channels 538 and 540 is derived by the controller 500 directly from metadata 552, which is received together with the encoded stereo signal from the teleconference bridge 300, as indicated at 508. When spatializing the received mono audio channels into stereo audio, the teleconference bridge 300 will include spatial position information of the active sound source (e.g., the current speaker) in the metadata 552. The receiving user terminal 500 will use this spatial position information in the metadata to select the correct ITD value in the error concealment process. In more detail, as one example, the teleconference bridge 300 may use 4 bits to approximate the ITD directly in milliseconds. 1 bit could be used as a sign bit and 3 remaining bits for ITD value in milliseconds, thereby giving an effective ITD range of −0.7 to +0.7 milliseconds in 0.1 ms steps. This information could be assigned to each of the (pairs of) speech frames, or it could be sent more rarely, e.g. with every 10th frame only. Whenever frames are lost, the error concealment process uses previously correctly received spatial position information in the error concealment processing.

Thus, there is no need for any local means, such as the phase & simultaneous speech estimator 412 of FIG. 4, for estimating the phase difference between the channels from the received audio signal. Other than this, the embodiment of FIG. 5 has like components, indicated by like reference numerals, and operates in a manner which is fully equivalent with that of the FIG. 4 embodiment.

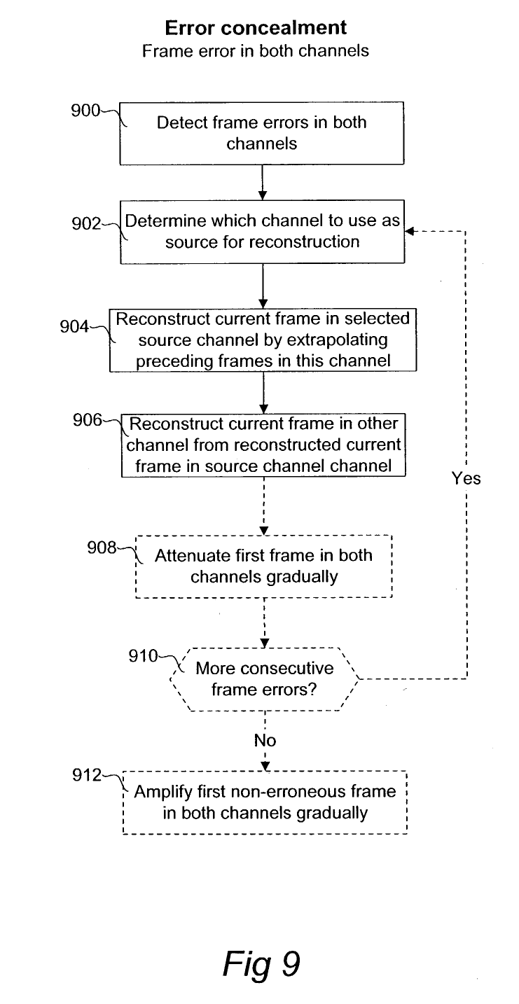

With reference to FIG. 9, an error concealment procedure for a situation with concurrent frame errors in both channels is illustrated. As previously mentioned, if audio frames are simultaneously corrupted or missing in both of the channels, to prevent a shift of sound source location, the audio signal for one channel is first reconstructed (from preceding frames in that channel), and then the other channel is reconstructed based on the first reconstructed channel in the manner described above.

Starting with step 900 it is determined that audio frame errors have occurred in simultaneous frames for both channels. In step 902 a determination is made as to which channel to use as source for initial frame reconstruction. This determination may be made by investigating the signal energy or power level of the two channels and then selecting, as source channel, the one of the channels which has the highest signal energy or power level. Alternatively, the phases of the two channels may be determined, wherein the one of the channels which has leading phase is selected as source channel.

In step 904 the erroneous frame of the selected source channel is reconstructed from preceding correctly received frames of that channel. There are known methods of such intra-channel frame reconstruction which may be used in step 904. Extrapolation by attenuated copying of previous frames is one example.

Then, in step 906, the concurrent erroneous frame of the other channel is reconstructed from the just reconstructed source channel frame in the manner described above and illustrated in FIG. 8. optionally, as indicated with dashed lines in FIG. 9, the quality of the reconstructed output signals can be further improved by controlling the signal gain in the mixer 436/536. After the reconstruction, both channels could be attenuated gradually down to e.g. −10 dB during the first erroneous frame, as shown in step 908. The level of the signals is then kept low for consecutive frame errors, until it is determined, in step 910, that there are no more consecutive erroneous frames to be corrected. Upon this determination, the first non-erroneous frame in each channel is amplified gradually back to a 0 dB level, as seen in step 912. This option is particularly useful when frames have been lost in both channels, but it may also be applied to the error concealment of single-channel errors illustrated in FIG. 8.

An alternative embodiment of error concealment with preserved spatial sensation according to the invention will now be described. This alternative embodiment suggests a modification or extension of the typical intra-channel error concealment methods of contemporary speech codecs so as to make use also of audio data on the other channel for reconstructing erroneous audio frames. In this alternative embodiment, error concealment occurs in the “parameter” domain rather than time domain.

First, some high-level principles of speech compression and error concealment will be introduced to better illustrate the fundamentals of this embodiment. In modern speech codecs, such as 3GPP AMR (Adaptive Multi-Rate), the encoder transforms the input speech into a set of parameters that describe the contents of the current frame. These frames are transmitted to the decoder, which uses the parameters to reconstruct a speech signal sounding as closely as possible like the original signal. For example, the parameters transmitted by the AMR codec for each frame are a set of line spectral frequencies (LSFs) for forming the LP synthesis filter, pitch period and pitch gain for the adaptive codebook excitation, and pulse positions and gain for the fixed codebook excitation.

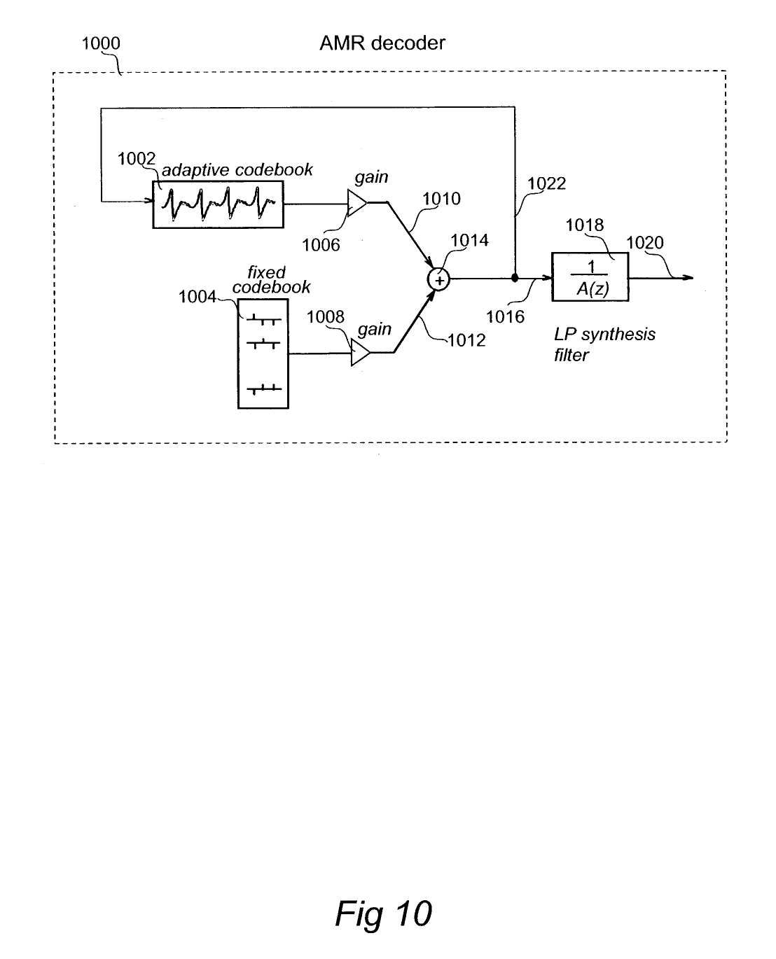

FIG. 10 shows a simplified block diagram of an AMR decoder 1000. The adaptive codebook excitation 1010 is formed by copying the signal from the adaptive codebook 1002 from the location indicated by the received pitch period, and multiplying this signal with the received pitch gain, as seen at 1006. The fixed codebook excitation 1012 for the fixed codebook 1004 is built based on received pulse positions and by multiplying this signal with the received fixed codebook gain, as seen at 1008. The sum 1014 of adaptive codebook and fixed codebook excitations 1010, 1012 forms the total excitation 1016, which is processed by an LP synthesis filter 1018, formed based on the received LSFs, to reproduce a synthesized speech signal 1020. Furthermore, the total excitation 1016 is also fed back, at 1022, to the adaptive codebook memory to update the adaptive codebook 1002 for the next frame.

Since, in short term, the speech signal is quite stationary in nature (in terms of energy level and spectral content), also many of the parameters used to describe the signal will evolve relatively slowly over time. While this short-term stationarity is one of the fundamentals of efficient compression that exploits intra-channel, inter-frame dependency, it also enables quite efficient error concealment techniques simply by extrapolating the parameter values based on their values in previous frame(s) in the same channel. An example solution for the error concealment for the AMR codec is thoroughly described in “3GPP TS 26.091 AMR speech codec; Error concealment of lost frames (Release 4), version 4.0.0 (2001-03)”.

Since the error concealment is performed in the “parameter domain” (instead of modifying the signal in the time domain), this will also be a computationally efficient operation, which can be performed generally by using the same algorithms as normal speech decoding. The general principle of smooth error concealment is to avoid annoying sounds by gradually downscaling the signal energy and forcing the spectrum more and more flat by modifying the parameter values by predefined factors. However, despite the assumed stationarity, the parameters are naturally gradually changing over time, and with increasing number of consecutive missing frames the result of error concealment gets worse and worse.

For instance, in case of a lost frame, the example approach to error concealment in the AMR codec computes the LSF parameters by shifting the LSF values from the previous frame slightly towards their means, resulting in a “flatter” frequency envelope. The pitch period is either directly copied or slightly modified from the previous frame. For pitch gain and fixed codebook gain slightly adjusted (“downscaled”) values are used, based on the few most recently received values. The pulse positions of the fixed codebook excitation are not assumed to have dependency between successive frames (on the same channel), and the error concealment procedure can select them randomly. However, with an increasing number of consecutive missing frames the “downscaling” factor for pitch gain and fixed codebook gain is increased, resulting eventually in total muting of the decoder output after five or six missing frames.

In view of the above, the aforesaid alternative embodiment of the invention proposes two different error concealment scenarios for two-channel spatial speech.

A. Frame missing only from one channel:

Since in a spatialized stereo teleconference application or a stereo music application the two channels are highly correlated, the parameters received in the frame for the other channel can be used to enhance the error concealment performance on the channel where the frame is missing. Even if there is a small phase difference between the channels (in the range from −6 to +6 samples, as described earlier), when the parameters of a frame are evaluated e.g. over 160 samples (corresponds to 20 ms frame length at 8 kHz sample rate), parameter estimation based on the other (non-erroneous) channel will give a better approximation of the real parameter values than the ones that have been extrapolated within the channel with the erroneous frame. Thus, error concealment will work better when parameter information from the other channel can be used in addition to normal extrapolation-based parameter estimation. For example, in standard error concealment for the AMR codec the pitch gain and codebook gain are downscaled based on previously received values according to a predefined pattern (reference is made to the AMR specification referred to above for details). This has proven to be a good and safe solution for a single-channel case, but it will not give optimum performance for a spatialized two-channel case.

For example, consider a situation where these gain values would be changing towards larger values in the frame that has been lost or corrupted: the standard AMR error concealment would downscale the signal in the erroneous channel, while in the other channel the signal level would go up according to the actual data in the correctly received frame, thus generating a clear difference between the channels. As a result, the spatial image would move to a “wrong” position. Thus, the invention proposes using parameter information received for the other channel to enhance the error concealment performance of the erroneous channel by indicating the correct “trend” of the change of the signal characteristics (e.g. scaling signal value up instead of down). This would yield better speech quality.

Improved two-channel error concealment performance could be reached by directly copying the LSFs from the non-erroneous channel, or adjusting these values slightly towards values computed by the “normal” error concealment procedure for the erroneous channel. Similarly, the pitch period, pitch gain, and fixed codebook gains for the erroneous channel can be taken from the non-erroneous channel, either directly or modified with a scaling factor. The scaling factor could be adaptive in such a way that its value is constantly updated to be the ratio between the parameter (i.e. pitch period, pitch gain, or fixed codebook gain) values in both channels. Furthermore, the scaling factor could also take into account the parameter value history of the erroneous channel. Although it is considered to be sufficient to just randomize the fixed codebook excitation pulse positions, this might cause a phase difference for a two-channel spatialized signal, especially during unvoiced speech where the fixed codebook typically provides the major contribution to the total excitation. Therefore, in a two-channel case, the error concealment performance would be improved if the pulse positions are copied from the non-erroneous channel and shifted according to the ITD before forming the total excitation used in the erroneous channel.

B. Frame missing from both channels:

When frames from both channels are lost, there is naturally no redundant information to be used to enhance the actual error concealment. However, also in this case knowledge of phase and energy difference between channels can be used to improve speech quality by preserving the spatial position also in the extrapolated signal. Either of the channels is simply selected as the “source channel” (for instance the one with higher energy level), and the error concealment is performed for this channel as in the standard single-channel case. After this, the extrapolated frame is regarded as if it were a normally received frame, and the error concealment is performed as described above in case A. This approach makes sure that the concealment on both channels changes the parameter values according to a similar pattern, thus minimizing the deviation between the channels that might shift the spectral position.

Various alternatives may be applied to the embodiments described above. Some of those alternatives will be briefly mentioned below, in a non-exhaustive manner.

As regards the phase difference between the channels, one possibility to improve the detection of ITD is to analyze the spectrum of signals in bands and take advantage of frequency dependency of ILD. In HRTF processed signals the ITD value correlates with the effect of head shadow, which has low-pass filter characteristics. Thus, a sound source that is at the right side of the listener (positive ITD) has less high frequency energy in the left channel (farther ear) than in the right channel (nearer ear). The more the high frequencies of the signal are attenuated at the farther ear side comparing to the nearer ear side, the farther the sound source is spatialized from the center. This method requires knowledge of the spatialization algorithm used in the teleconference bridge.

When reconstructing an erroneous audio frame in the spatial reconstruction unit 434, it is possible to use different filters depending on the spatial position of the sound source and the reconstruction direction, i.e. whether it is from contra-lateral to ipsi-lateral or vice versa. If the contra-lateral channel is lost, it can be generated by low-pass filtering of the ipsi-lateral channel. Correspondingly, the ipsi-lateral channel can be generated by boosting the high frequencies of the contra-lateral channel. This approach requires knowledge of the spatialization algorithm used in the teleconference bridge 300.

In case of simultaneous audio frame errors on both channels, if frames are lost or corrupted in the middle of a voiced sound, it might be useful to replace a few consecutive correct frames after the last erroneous frame. When the decoder extrapolates a lost frame (e.g. step 904 in FIG. 9), it automatically attenuates output signal level. Correspondingly, when the next non-erroneous frame is decoded, output signal level is gradually amplified to the target level. This can cause discontinuity in the amplitude envelope at the border between a reconstructed frame and the following non-erroneous frame, which can be heard as a click. To overcome this problem extra frames could be processed.

Additionally, if there are more than 6 missing frames at both channels, it might not be necessary to process the additional frames exceeding this number. The decoder would already have attenuated the signal level during extrapolation down to a mute level.

The error concealment method of the invention works also for binaural recordings or speech that is captured from a conference room by two microphones.

Moreover, it can be applied to a stereo codec or dual mono codecs as well, such as the audio encoding/decoding block 260 indicated in FIG. 2 which may be a MPEG-4 or MPEG-2 AAC (Advanced Audio Coding) codec, an ISO/MPEG Audio Layer-3 (MP3) codec, or two mono codecs such as GSM EFR/FR/HR speech codec, AMR, Wideband AMR, G.711, G.722, G.722.1, G.723, G.728, or according to MPEG1/2/4 CELP+AAC codec. If a frame has been lost during transmission, the extrapolated signal can be spatialized to the correct location at the terminal using the method according to the invention. The error concealment method could be applied in a stereo codec for transmitting spatial speech. The error concealment method would extrapolate, in addition to signal waveform, the spatial position. The presented method could be integrated in a stereo codec which allows to specify the content of the signal as a meta information. The method would be taken into use whenever it is specified that the signal is spatialized speech.

The presented error concealment method works best if room effect (reverb) is added to the spatialized signals in the terminal after the error concealment processing. If the room effect is processed already in the teleconference bridge, the error concealment at the terminal spatializes also the reverb energy, which is supposed to be diffuse and non-spatial from the listener's aspect, to the same spatial position in which the sound source is localized. This may degrade the spatial audio quality a bit, because the feeling of audio immersion degrades. However, because the error concealment works at a short time scale (typically 20-200 ms), this might not be a noticeable problem in most cases. In addition, when the room effect is added in the terminal it can even mask some anomalies that are generated in the error concealment process.

The error concealment functionality described above may be realized as an integrated circuit (ASIC) or as any other form of digital electronics. In an alternative embodiment, the error concealment functionality may be implemented as a computer program product, which is directly loadable into a memory of a processor. The processor may be any CPU, DSP or other kind of microprocessor which is commercially available for personal computers, server computers, palmtop computers, laptop computers, etc, and the memory may be e.g. RAM, SRAM, flash, EEPROM and/or an internal memory in the processor. The computer program product comprises program code for providing the error concealment functionality when executed by the processor.

It is to be emphasized, again, that the invention is not limited to two channels but may be applied to an arbitrary number of channels in excess of a single channel. For instance, the invention could be applied to a 4.1, 5.1 or 6.1 digital audio format, or any other so-called 3D or spatial audio format, or in general any two channels which carry audio information and are temporally highly correlated, i.e. derived essentially from the same sound source.

The invention could be extended into a case where ITD detection is done separately for each sub-band between the input signals. As a result, an estimate of spatial position of the sound source at each sub-band will be detected. When frame loss happens, in the error concealment processing all these positions would be preserved separately. This method would suit multi-speech signals and music. To this end, a method of detecting the location of a sound source is described in Liu, C., Wheeler, B. C., O'Brien, W. D., Bilger, R. C., Lansing, C. R., and Feng, A. S. “Localization of multiple sound sources with two microphones”, J. Acoust. Soc. Am. 108 (4), pp. 1888-1905, October 2000, which is incorporated herewith by reference.

The invention has mainly been described above with reference to a few embodiments. However, as is readily appreciated by a person skilled in the art, other embodiments than the ones disclosed above are equally possible within the scope of the invention, as defined by the appended patent claims.

What we claim and desire to secure by letters patent is:

1. An error concealment method for multi-channel digital audio, the method comprising the steps of receiving an audio signal having audio data forming a first audio channel and a second audio channel included therein, said first and second audio channels being correlated with each other in a manner so that a spatial sensation is typically perceived when listened to by a user;
detecting erroneous first-channel data in the first audio channel;
obtaining second-channel data from the second audio channel;
determining, upon detection of the erroneous first-channel data, a spatially perceivable inter-channel relation between the first and second audio channels; and correcting the erroneous first-channel data of the first audio channel by using the second-channel data and the determined inter-channel relation so as to preserve the spatial sensation perceived by the user.

2. A method as in claim 1, wherein the erroneous first-channel data of the first audio channel is corrected by manipulating the second-channel data in accordance with the determined inter-channel relation and then replacing the erroneous first-channel data with manipulated second-channel data.

3. A method as in claim 2, wherein the determined inter-channel relation is a phase difference between the first and second audio channels.

4. A method as in claim 3, wherein the manipulation of the second-channel data comprises selecting said second-channel data from the second audio channel with a time shift with respect to the first audio channel, said time shift corresponding to the determined phase difference.

5. A method as in claim 3, wherein the phase difference is determined by analyzing the first and second channels of the received audio signal with respect to each other.

6. A method as in claim 5, wherein the analysis of the first and second channels of the received audio signal involves:
low-pass filtering of each of the first and second channels; and
detecting the phases of the first and second channels after low-pass filtering by matching peaks or zero-crossings, or both in voiced phonemes.

7. A method as in claim 1, wherein the spatially perceivable inter-channel relation is determined from metadata received together with the audio signal.

8. A method as in claim 1, comprising the additional step of decoding the received audio signal prior to said step of detecting erroneous first-channel data in the first audio channel.

9. A method as in claim 1, wherein the first and second audio channels each comprises a plurality of audio frames and wherein the detection and correction of erroneous first-channel data concern at least one entire audio frame.

10. A method as in claim 1, wherein the first and second audio channels each comprises a plurality of audio frames and wherein the detection and correction of erroneous first-channel data concern part or parts of an audio frame.

11. A method as in claim 10, wherein said part or parts of an audio frame relates to one or more spectral sub-bands.

12. A method as in claim 9, wherein the detection and correction of erroneous first-channel data is performed on a plurality of time domain audio samples contained in the audio frame.

13. A method as in claim 1, wherein the first and second audio channels are left and right stereo channels, or vice versa.

14. A method as in claim 1, comprising the additional steps, after said step of detecting erroneous first-channel data in the first audio channel, of:
detecting erroneous second-channel data in the second audio channel, essentially concurrent with the erroneous first-channel data detected in the first audio channel;
selecting either the first audio channel or the second audio channel as source channel for audio reconstruction;
reconstructing the erroneous data of the selected source channel from preceding data in the selected source channel; and
reconstructing the erroneous data of the other of the first and second audio channels, which was not selected as source channel, from the reconstructed data of the source channel in accordance with the remaining steps of claim 1.

15. A method as in claim 14, wherein the one of the first audio channel or the second audio channel which has the highest signal energy or power level is selected as source channel.

16. A method as in claim 14, wherein the one of the first audio channel or the second audio channel which is leading in terms of phase is selected as source channel.

17. A method as in claim 16, wherein said step of reconstructing the erroneous data of the selected source channel from preceding data in the selected source channel is performed by attenuated extrapolation or copying of said preceding data.

18. A method as in claim 1, wherein the audio signal is received from a teleconference bridge.

19. A method as in claim 1, wherein the audio signal is received from a stereo music server.

20. A method as in claim 1, wherein the audio signal is received over a radio network, a fixed telecommunications network, a mobile telecommunications network, a short-range optical link or a short-range radio link.

21. A method as in claim 14, comprising the additional steps of attenuating the reconstructed data of said source channel and said other channel;
maintaining the first and second audio channels attenuated for as long as there are consecutive errors on the first and second audio channels; and
upon detecting that there are no more consecutive errors on the first and second audio channels, amplifying the first and second audio channels to cancel the attenuation thereof.

22. A method as in claim 1, wherein the step of correcting the erroneous first-channel data of the first audio channel involves using the second-channel data of the second audio channel as well as preceding non-erroneous first-channel data of the first audio channel.

23. A method as in claim 22 and comprising the additional step of decoding the received audio signal prior to said step of detecting erroneous first-channel data in the first audio channel, wherein the received audio signal is decoded by at least one codec, such as an MPEG4 or MPEG-2 AAC codec, an ISO/MPEG Audio Layer-3 (MP3) codec, or two mono codecs like GSM EFR/FR/HR speech codec, AMR, Wideband AMR, G. 711, G. 722, G. 722.1, G. 723, G. 728, or an MPEG1/2/4 CELP+AAC codec.

24. A method as in claim 1, wherein the detection and correction of erroneous first-channel data concern a audio component or components, such as a principal audio component or components, which is or are detected or indicated to be present in the audio signal.

25. A computer program product directly loadable into a memory of a processor, where the computer program product comprises program code for performing the method according to claim 1 when executed by said processor.

26. An integrated circuit, which is adapted to perform the method according to claim 1.

27. A receiver of multi-channel digital audio, comprising means for receiving an audio signal having audio data forming a first audio channel and a second audio channel included therein, said first and second audio channels being correlated with each other in a manner so that a spatial sensation is typically perceived when listened to by a user;
means for detecting erroneous first-channel data in the first audio channel;
means for obtaining second-channel data from the second audio channel;
means for correcting the erroneous first-channel data of the first audio channel by using the second-channel data; and
means for determining, upon detection of the erroneous first-channel data, a spatially perceivable inter-channel relation between the first and second audio channels, wherein
said means for correcting the erroneous first-channel data of the first audio channel is adapted to use the determined inter-channel relation when correcting the erroneous first-channel data so as to preserve the spatial sensation perceived by the user.

28. A user terminal for a communications network, the user terminal comprising an integrated circuit according to claim 26.

29. A user terminal for a communications network, the user terminal comprising a receiver according to claim 27.

30. A user terminal as in claim 28, wherein the communications network includes a mobile telecommunications network and the user terminal is a mobile terminal.

31. A user terminal as in claim 28, adapted to receive the audio signal from a teleconference bridge over the communications network.

32. A user terminal as in claim 29, wherein the communications network includes a mobile telecommunications network and the user terminal is a mobile terminal.

33. A user terminal as in claim 29, adapted to receive the audio signal from a teleconference bridge over the communications network.

34. A teleconference system comprising a communications network, a plurality of user terminals according to claim 28 and a teleconference bridge, wherein the user terminals are connected to the teleconference bridge over the communications network.

35. A teleconference system comprising a communications network, a plurality of user terminals according to claim 29 and a teleconference bridge, wherein the user terminals are connected to the teleconference bridge over the communications network.
